(19) United States
(12) Patent Application Publication
(10) Pub. No.: US 2011/0029325 A1
(43) Pub. Date: Feb. 3, 2011

(54) METHODS AND APPARATUS TO ENHANCE HEALTHCARE INFORMATION ANALYSES

(75) Inventors: Emil Markov Georgiev, Hartland, WI (US); Erik Paul Kemper, Franklin, WI (US)

Correspondence Address: HANLEY, FLIGHT & ZIMMERMAN, LLC, 150 S. WACKER DRIVE, SUITE 2100, CHICAGO, IL, 60606, US

(73) Assignee: General Electric Company, a New York Corporation, Schenectady, NY (US)

(21) Appl. No.: 12/510,842

(22) Filed: Jul. 28, 2009

(51) Int. Cl. G06Q 50/00; G10L 13/08; G10L 21/00

(52) U.S. Cl. 705/3; 705/2; 704/260; 704/270; 704/E21.001; 704/E13.008

(57) ABSTRACT

Methods and apparatus to enhance healthcare information analyses are disclosed herein. An example method for use with a healthcare information system includes automatically detecting a scheduled analysis of healthcare information associated with a patient based on a detection of the patient; retrieving textual data corresponding to a medical history of the patient from an information source according to a first configuration setting, wherein the first configuration setting controls which of a plurality of aspects of the medical history is to be retrieved; generating a report using the textual data according to a second configuration setting, wherein the second configuration setting controls an organization of the generated report; converting the report to an audio file and storing the audio file in memory; and in response to detecting an initiation of the scheduled analysis, outputting at least a first segment of the audio file on a presentation device associated with the scheduled analysis in conjunction with a presentation of one or more images associated with the scheduled analysis.

### FIELD OF THE DISCLOSURE

The present disclosure relates generally to healthcare information systems and, more particularly, to methods and apparatus to enhance healthcare information analyses.

### BACKGROUND

Healthcare environments, such as hospitals and clinics, typically include information systems (e.g., electronic medical record (EMR) systems, lab information systems, outpatient and inpatient systems, hospital information systems (HIS), radiology information systems (RIS), storage systems, picture archiving and communication systems (PACS), etc.) to manage information such as, for example, patient medical histories, imaging data, test results, diagnosis information, management information, financial information, and/or scheduling information. Practitioners access the healthcare information at various stages in a healthcare workflow to provide treatment.

### SUMMARY

An example computer implemented method for use with a healthcare information system includes automatically detecting a scheduled analysis of healthcare information associated with a patient based on a detection of the patient. Further, the example computer implemented method includes retrieving textual data corresponding to a medical history of the patient from an information source according to a first configuration setting, wherein the first configuration setting controls which of a plurality of aspects of the medical history is to be retrieved. Further, the example computer implemented method includes generating a report using the textual data according to a second configuration setting, wherein the second configuration setting controls an organization of the generated report. Further, the example computer implemented method includes converting the report to an audio file and storing the audio file in memory. Further, the example computer implemented method includes, in response to detecting an initiation of the scheduled analysis, outputting at least a first segment of the audio file on a presentation device associated with the scheduled analysis in conjunction with a presentation of one or more images associated with the scheduled analysis.

An example tangible machine readable medium has instructions stored thereon that, when executed, cause a machine to automatically detect a scheduled analysis of healthcare information associated with a patient based on a detection of the patient. Further, the example tangible machine readable medium has instructions stored thereon that, when executed, cause a machine to retrieve textual data corresponding to a medical history of the patient from an information source according to a first configuration setting, wherein the first configuration setting controls which of a plurality of aspects of the medical history is to be retrieved. Further, the example tangible machine readable medium has instructions stored thereon that, when executed, cause a machine to generate a report using the textual data according to a second configuration setting, wherein the second configuration setting controls an organization of the generated report. Further, the example tangible machine readable medium has instructions stored thereon that, when executed, cause a machine to convert the report to an audio file and storing the audio file in memory. Further, the example tangible machine readable medium has instructions stored thereon that, when executed, cause a machine to, in response to detecting an initiation of the scheduled analysis, output at least a first segment of the audio file on a presentation device associated with the scheduled analysis in conjunction with a presentation of one or more images associated with the scheduled analysis.

An example apparatus for use with a healthcare information system includes a detector to automatically detect a scheduled analysis of healthcare information associated with a patient based on a detection of the patient. Further, the example apparatus includes a data extractor to retrieve textual data corresponding to a medical history of the patient from an information source according to a first configuration setting, wherein the first configuration setting controls which of a plurality of aspects of the medical history is to be retrieved. Further, the example apparatus includes a report generator to generate a report using the textual data according to a second configuration setting, wherein the second configuration setting controls an organization of the generated report. Further, the example apparatus includes a converter to convert the report to an audio file and storing the audio file in memory. Further, the example apparatus includes a communication interface to, in response to detecting an initiation of the scheduled analysis, output at least a first segment of the audio file on a presentation device associated with the scheduled analysis in conjunction with a presentation of one or more images associated with the scheduled analysis.

### BRIEF DESCRIPTION OF THE DRAWINGS

FIG. 1 is a block diagram of an example healthcare information system.

FIG. 2 is a block diagram of an example apparatus that may be used to implement the example analysis module of FIG. 1.

FIG. 3 is a flow diagram representative of example machine readable instructions that may be executed to implement the example analysis module of FIGS. 1 and/or 2.

FIG. 4 is a sequence diagram representing machine readable instructions that may be executed to implement the example components of the example healthcare information system of FIGS. 1 and/or 2.

FIG. 5 is a block diagram of an example processor system that may be used to execute the machine readable instructions of FIGS. 3 and/or 4 to implement the example report analysis module of FIGS. 1 and/or 2.

The foregoing summary, as well as the following detailed description of certain implementations of the methods, apparatus, systems, and/or articles of manufacture described herein, will be better understood when read in conjunction with the appended drawings. It should be understood, however, that the methods, apparatus, systems, and/or articles of manufacture described herein are not limited to the arrangements and instrumentality shown in the attached drawings.

### DETAILED DESCRIPTION

Although the following discloses example methods, apparatus, systems, and articles of manufacture including, among other components, firmware and/or software executed on hardware, it should be noted that such methods, apparatus, systems, and/or articles of manufacture are merely illustrative and should not be considered as limiting. For example, it is contemplated that any or all of these firmware, hardware, and/or software components could be embodied exclusively in hardware, exclusively in software, exclusively in firmware, or in any combination of hardware, software, and/or firmware. Accordingly, while the following describes example methods, apparatus, systems, and/or articles of manufacture, the examples provided are not the only way(s) to implement such methods, apparatus, systems, and/or articles of manufacture.

Healthcare practitioners (e.g., physicians, surgeons, support staff, etc.) spend a significant amount of time analyzing various types of healthcare information including, for example, radiology images, ultrasound images, magnetic resonance imaging (MRI) scans, etc. The purpose of an analysis may range from diagnosing a condition, assessing a recovery process, identifying abnormalities, and/or otherwise caring for a patient. To properly analyze the healthcare information, practitioners often review additional information having the potential to influence a finding, a diagnosis, and/or an assessment of the healthcare information. That is, practitioners do not analyze healthcare information as a standalone record or report. Rather, practitioners utilize additional information such as, for example, a medical history associated with the patient, to provide a context in which the healthcare information is analyzed. For example, in reviewing a radiology image, knowledge of a prior surgery related to the relevant anatomy could explain certain anatomical features that might otherwise be perceived as findings.

The healthcare information being directly analyzed by a practitioner during an analysis (e.g., a radiology image, an ultrasound image, an MRI scan, etc.) is sometimes referred to herein as primary data, while the additional information related to the primary data (e.g., a medical history associated with the patient, information from an order of the analysis such as, for example, a reason the analysis of the primary data was ordered by a physician) is sometimes referred to herein as secondary data. However, these terms are not meant to place a degree of importance or rank on either type of information, but are meant for purposes of clarity and brevity in illustrating the example methods, apparatus, systems, and/or articles described herein.

Conventional systems impose upon practitioners the task of identifying and retrieving secondary data deemed useful and/or necessary to properly analyze the primary data. Further, conventional systems impose upon practitioners the task of separately reviewing the primary data and the secondary data. Analyzing clinical images is an intense visual activity that requires a high degree of concentration on the part of the reviewing practitioner. Shifting visual focus from the clinical images to, for example, review some or all of the secondary data, amounts to a distraction from the visual analysis of the clinical images. In some instances, the secondary data is in paper form, thereby requiring the reviewing practitioner to shift his or her focus from the primary data to a desk on which the printed secondary data rests. In some instances, the secondary data is in electronic form on a monitor adjacent the primary data, thereby requiring the practitioner to shift his or her focus from one monitor to another. Further, the practitioner is required to shuffle the secondary data to access different portions or segments thereof. To continue the above examples, the practitioner may have to shuffle between sheets of printed secondary data or may have to click on links or icons on an adjacent monitor to view different electronic files of secondary data.

Generally, the example methods, apparatus, systems, and/or articles of manufactures described herein improve delivery of healthcare information to be analyzed by a practitioner. For example, the example methods, apparatus, systems, and/or articles of manufacture described herein identify and/or extract secondary data relevant to an analysis of primary data in response to detecting, for example, an arrival of the patient at a healthcare facility, an onset of a patient preparation procedure, an acquisition of healthcare images, and/or a transfer of healthcare images. Further, the example methods, apparatus, systems, and/or articles of manufacture described herein enable a practitioner to maintain visual focus on primary data while also reviewing secondary data. For example, the example methods, apparatus, systems, and/or articles of manufacture described herein make secondary data available in audio form such that the practitioner may visually review the primary data while listening to an audio report including the secondary data. Additional aspects of the example methods, apparatus, systems, and/or articles of manufacture are described in greater detail below in connection with an example medical data system.

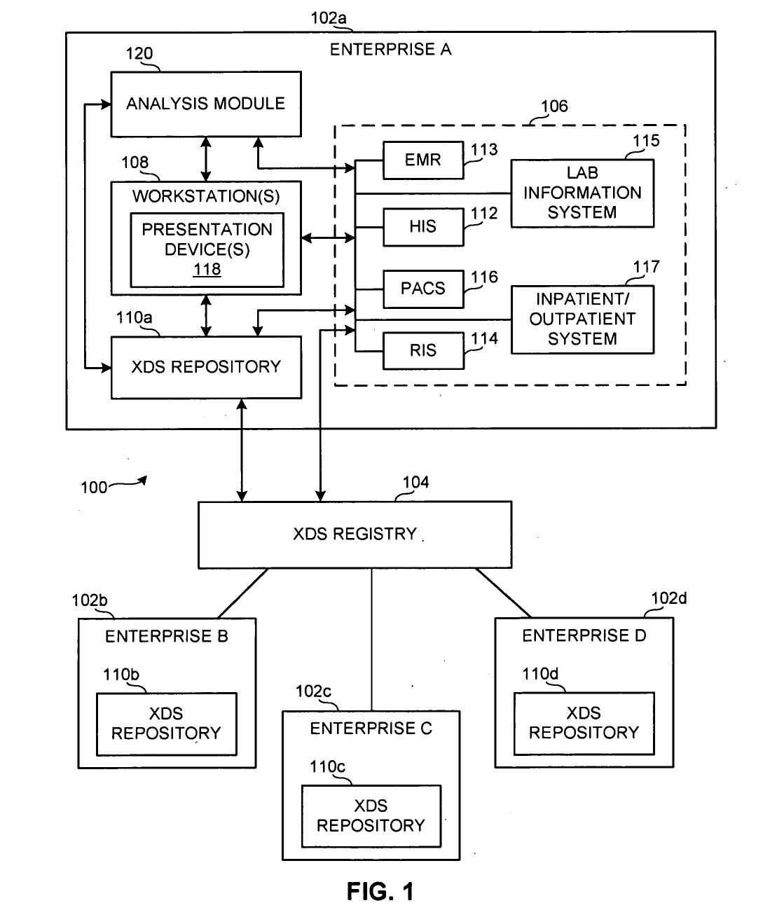

FIG. 1 is a block diagram of an example medical data system 100 capable of implementing the example methods, apparatus, systems, and/or articles of manufacture described herein to enhance healthcare information analyses. The example medical data system 100 of FIG. 1 includes a plurality of healthcare enterprises 102a-d. In the illustrated example of FIG. 1, the enterprise labeled with reference numeral 102a is illustrated and described herein as a hospital. However, any of the enterprises 102a-d may be any type of healthcare facility such as, for example, a clinic, a physician's office, a laboratory, a testing center, etc. Further, while FIG. 1 illustrates the components of the hospital 102a, the other enterprises (enterprises 102b-d) may include additional, alternative, and/or similar components, although not shown in FIG. 1 for purposes of brevity and not limitation.

The example medical data system 100 of FIG. 1 implements an Integrating the Healthcare Enterprise (IHE) Cross Enterprise Document Sharing (XDS) integration profile to facilitate the sharing (e.g., registration, distribution, access, etc.) of medical data among the healthcare enterprises 102a-d (referred to as an Affinity Domain in IHE XDS terminology) via a common registry 104. The XDS profile includes a common set of standards or policies for the healthcare enterprises 102a-d, which agree to share medical data using a common infrastructure. While the example medical data system 100 of FIG. 1 is shown as implemented by a XDS integration profile, any additional or alternative medical data sharing system (e.g., any health information exchanges (HIEs) and/or regional health information organizations (RHIOs) designed to enable a plurality of healthcare enterprises to exchange healthcare information) can be used to implement the example methods, apparatus, systems, and/or articles of manufacture described herein. Moreover, the example methods, apparatus, systems, and/or articles of manufacture described herein may be implemented on a medical data system 100 without information sharing capabilities, such as a standalone physician office or clinic.

The example hospital 102a includes a healthcare information system 106, one or more workstations 108, and a repository 110a. The healthcare information system 106 includes a hospital information system (HIS) 112, an electronic medical record system (EMR) 113, a radiology information system (RIS) 114, a lab information system 115, a picture archiving and communication system (PACS) 116, and an inpatient/outpatient system 117. In the illustrated example, the hospital information system 112, the electronic medical record system 113, the radiology information system 114, the lab information system 115, the PACS 116, and the inpatient/outpatient system 117 are housed in the hospital 102a and locally archived. However, in other implementations, one or more elements of the example healthcare information system 106 may be housed one or more other suitable locations. Furthermore, one or more components of the medical information system 106 may be combined and/or implemented together. For example, the radiology information system 114 and/or the PACS 116 may be integrated with the hospital information system 112; the PACS 116 may be integrated with the radiology information system 114; and/or the six example information systems 112, 113, 114, 115, 116, and/or 117 may be integrated together. Preferably, information (e.g., test results, observations, diagnosis, discharges, admissions, findings, reports, etc.) is entered into the elements of the example healthcare information 106 by healthcare practitioners (e.g., radiologists, physicians, technicians, administrators, etc.) before, after, and/or during a patient examination and/or testing session. In some examples, the equipment (e.g., an MRI machine) of these systems (e.g., the PACS 116) stores the information (e.g., an MRI scanned image) automatically upon acquiring the information.

The hospital information system 112 stores healthcare information such as clinical reports, patient information, practitioner information, and/or financial data received from, for example, personnel at a hospital, clinic, and/or a physician's office. The EMR system 113 stores information related to patients and/or practitioners, medical histories, current treatment records, etc. The radiology information system 114 stores information such as, for example, radiology reports, x-ray images, messages, warnings, alerts, patient scheduling information, patient demographic data, patient tracking information, and/or physician and patient status monitors. Additionally, the radiology information system 114 enables exam order entry (e.g., ordering an x-ray of a patient) and image and film tracking (e.g., tracking identities of one or more people that have checked out a film).

The lab information system 115 stores clinical information such as lab results, test scheduling information, corresponding practitioner(s), and/or other information related to the operation(s) of one or more labs at the corresponding healthcare facility. The PACS 116 stores medical images (e.g., x-rays, scans, three-dimensional renderings, etc.) as, for example, digital images in a database or registry. Images are stored in the PACS 116 by healthcare practitioners (e.g., imaging technicians, physicians, radiologists) after a medical imaging of a patient and/or are automatically transmitted from medical imaging devices to the PACS 116 for storage. In some examples, the PACS 116 may also include a display device and/or viewing workstation to enable a healthcare practitioner to communicate with the PACS 1 16. The inpatient/outpatient system 117 stores information related to the admission and discharge of patients such as follow up schedules, patient instructions provided by a practitioner, prescription information, presenting symptoms, contact information, etc.

While example types of information are described above as being stored in certain elements of the healthcare information system 106, different types of healthcare data may be stored in one or more of the hospital information system 112, the EMR system 113, the radiology information system 114, the lab information system 115, the PACS 116, and/or the inpatient/outpatient system 1 17. Further, the information stored in these elements may overlap and/or share types of data.

The hospital information system 112, the EMR system 113, the radiology information system 1 14, the lab information system 115, the PACS 1 16, and/or the inpatient/outpatient system 117 may be in communication via, for example, a Wide Area Network (WAN) such as a private network or the Internet. More generally, any of the coupling(s) described herein, such as the coupling(s) between the registry 104 and any of the enterprises 102a-d, may be via a network. In such instances, the network may be implemented by, for example, the Internet, an intranet, a virtual private network, a wired or wireless Local Area Network, and/or a wired or wireless Wide Area Network. In some examples, the healthcare information system 106 also includes a broker (e.g., a Mitra Imaging's PACS Broker) to allow medical information and medical images to be transmitted together and stored together.

In some examples, information stored in one or more components of the medical information system 106 is formatted according to the HL-7 clinical communication protocol, the Digital Imaging and Communications in Medicine (DICOM) protocol, and/or any other suitable standard and/or protocol. The equipment used to obtain, generate, and/or store the information of the medical information system 106 may operate in accordance with the HL-7 clinical communication protocol, the DICOM protocol, and/or any other suitable standard and/or protocol.

The repository 110a, which is shown as an XDS repository in the example of FIG. 1, facilitates the sharing of healthcare documents generated by the medical information system 106 with other enterprises (e.g., enterprises 102b-d). In particular, the repository 110a receives images, medical reports, administrative information, financial data, insurance information, and/or other healthcare information from the healthcare information system 106 and stores such information in, for example, a database or any suitable data structure. Thus, to use XDS terminology, the medical information 106 is a document source that provides the repository 110a clinical data to be shared among the enterprises 102a-d. As shown in the example of FIG. 1, each of the enterprises 102b-d includes an XDS repository 110b-d that functions in a similar manner as the repository 110a of the hospital 102a.

Further, the repository 110a receives metadata associated with the images, medical reports, administrative information, financial data, insurance information, and/or other healthcare information from the medical information system 106 and forwards the metadata to the registry 104, which stores the metadata in a database 118. The metadata is used by the registry 104 to index the healthcare information stored at the repository 110a (along with the information stored at the repositories of the other enterprises 102b-d). The metadata corresponds to one of more types of identifying information (e.g., identification numbers, patient names, record numbers, social security numbers, payment status indicators, or any other identifying) associated with, for example, medical reports stored at the repository 110a. The registry 104 is capable of receiving queries into the contents of the repositories (e.g., the repository 110b of enterprise 102b) of the medical data system 100 and using the indexed metadata to satisfy the queries. For example, the registry 104 can perform a search of its contents and provide feedback (e.g., requesting clinical data or an indication of the lack thereof) regarding the same to one or more of the enterprises 102a-d and/or, more specifically, the repositories 110a-d.

The workstation(s) 108 may be any equipment (e.g., a personal computer) capable of executing software that permits electronic data (e.g., medical reports) and/or electronic medical images (e.g., x-rays, ultrasounds, MRI scans, clinical reports, test results, etc.) to be acquired, stored, or transmitted for viewing and operation. The workstation(s) 108 receive commands and/or other input from a user (e.g., a physician, surgeon, nurse, or any other healthcare practitioner) via, for example, a keyboard, mouse, track ball, microphone, etc. The workstation(s) include and/or are coupled to one or more presentation devices 118 (e.g., a standard computer monitor, speakers, touch-screen devices, specialized monitors to view specific images such as x-rays, magnetic resonance imaging (MRI) scans, etc.) capable of presenting images, video, audio, etc. to one or more practitioners.

Multiple workstations 108 can communicate with each other, the healthcare information system 106, and/or the XDS repository 110a and registry 104 to obtain shared medical information and convey the same to the user of the workstation(s) 108 via one or more of the presentation devices 118. Further, the workstation(s) 108 are capable of implementing a user interface to enable a healthcare practitioner to interact with the medical data system 100 and/or the registry 104 and the components thereof. In some examples, the user interface enables a search of one or more components or elements of the medical data system 100 and/or one or more external databases containing relevant healthcare information. A healthcare practitioner can use such a user interface to search medical resources using different criteria such as, for example, a patient name, a patient identification number, a social security number, date(s) of treatment(s), type(s) of treatment, and/or any other suitable search criteria.

To interact with one or more components of the medical information system 106, the workstation(s) 108 include and/or implement one or more applications programmed to, for example, retrieve information from a corresponding component of the healthcare information system 106, configure equipment associated with a corresponding component of the healthcare information system 106, present data associated with a corresponding component of the healthcare information system 106, and/or otherwise interact with one or more components of the healthcare information system 106. In the example of FIG. 1, dedicated application(s) are configured to interact with specific component(s) of the healthcare information system 106. For example, a PACS application is used to interact with the PACS 116, an inpatient/outpatient application is used to interact with the inpatient/outpatient system 117, etc. In some examples, one or more applications may be configured and/or programmed to interact with more than one element of the healthcare information system 106.

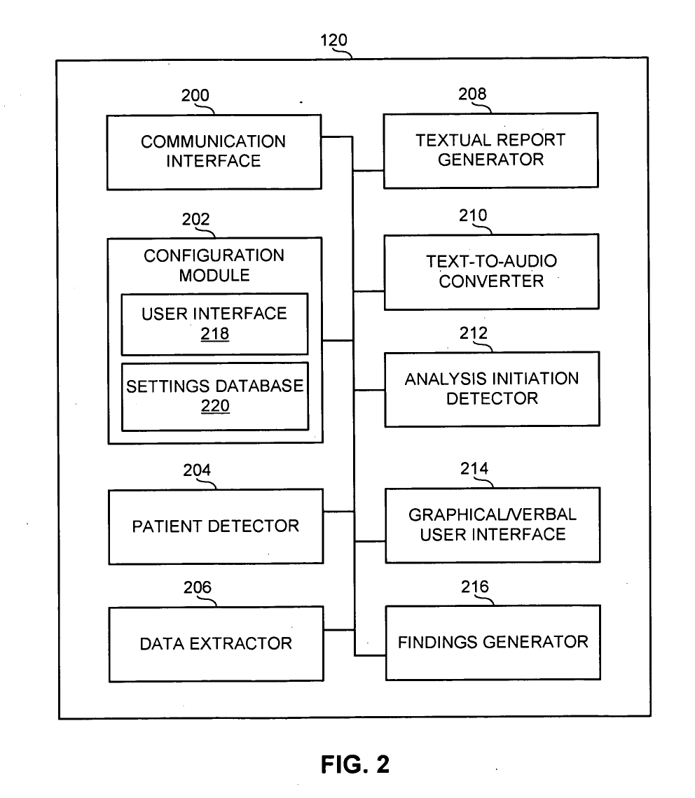

To enhance analyses of healthcare information as described herein, the workstation(s) 108 of FIG. 1 are in communication with an example analysis module 120. The example analysis module 120 can be implemented in additional or alternative elements and/or locations in the example medical data system 100 of FIG. 1 and/or any other type of medical data system. For example, the analysis module 120 may be implemented in one or more of the XDS repositories 110a-d, the XDS registry 104, the workstation(s) 108, and/or one or more elements of the medical information system 106 (e.g., the hospital information system 112, the electronic medical record system 113, the radiology information system 114, the lab information system 115, the PACS 116, and/or the inpatient/outpatient system 117). As described in greater below in connection with FIG. 2, the example analysis module 120 of FIG. 1 improves the delivery of healthcare information to a reviewing practitioner and enables the reviewing practitioner to more efficiently and effectively analyze primary data in light of secondary data. The example analysis module 120 provides additional or alternative features, benefits, and/or improvements as described below.

FIG. 2 is a block diagram of an example apparatus that may be used to implement the example analysis module 120 of FIG. 1. In the illustrated example of FIG. 2, the example report consolidation module 120 includes a communication interface 200, a configuration module 202, a patient detector 204, a data extractor 206, a textual report generator 208, a text-to-audio converter 210, an analysis initiation detector 212, a graphical/verbal user interface 214, and a findings generator 216. While an example manner of implementing the analysis module 120 of FIG. 1 has been illustrated in FIG. 2, one or more of the elements, processes and/or devices illustrated in FIG. 2 may be combined, divided, re-arranged, omitted, eliminated and/or implemented in any other way. Further, the example communication interface 200, the example configuration module 202, the example patient detector 204, the example data extractor 206, the example textual report generator 208, the example text-to-audio converter 210, the example analysis initiation detector 212, the example graphical/verbal user interface 214, the example findings generator 216, and/or, more generally, the analysis module 120 of FIG. 2 may be implemented by hardware, software, firmware and/or any combination of hardware, software and/or firmware. Thus, for example, any of the example communication interface 200, the example configuration module 202, the example patient detector 204, the example data extractor 206, the example textual report generator 208, the example text-to-audio converter 210, the example analysis initiation detector 212, the example graphical/verbal user interface 214, the example findings generator 216, and/or, more generally, the analysis module 120 of FIG. 2 can be implemented by one or more circuit(s), programmable processor(s), application specific integrated circuit(s) (ASIC(s)), programmable logic device(s) (PLD(s)) and/or field programmable logic device(s) (FPLD(s)), etc. When any of the appended claims are read to cover a purely software and/or firmware implementation, at least one of the example communication interface 200, the example configuration module 202, the example patient detector 204, the example data extractor 206, the example textual report generator 208, the example text-to-audio converter 210, the example analysis initiation detector 212, the example graphical/verbal user interface 214, the example findings generator 216, and/or, more generally, the analysis module 120 of FIG. 2 are hereby expressly defined to include a tangible medium such as a memory, DVD, CD, etc., storing the software and/or firmware. Further still, the example analysis module 120 of FIG. 2 may include one or more elements, processes and/or devices in addition to, or instead of, those illustrated in FIG. 2, and/or may include more than one of any or all of the illustrated elements, processes and devices.

To interact with one or more elements of the workstation(s) 108 and/or the medical information system 106 of FIG. 1, the example analysis module 120 of FIG. 2 includes the communication interface 200. For example, the communication interface 200 receives data, instructions, and/or any other suitable information from one or more of the elements of the analysis module 120 and conveys the same (e.g., after formatting the data accordingly) to a designated application of the workstation(s) 108. Further, the communication interface 200 receives data, instructions, and/or any other suitable information from application(s) of the workstation(s) 108 and/or other elements of the medical data system 100 and conveys the same to designated element(s) of the analysis module 120. In some examples, one or more of the elements of the example analysis module 120 communicate directly with, for example, the application(s) of the workstation(s) 108 without passing through the communication interface 200.

The example configuration module 202 of FIG. 2 facilitates the establishment, adjustment, and storage of a plurality of configuration settings associated with a plurality of practitioners associated with the example analysis module 120. To enable practitioners to establish, adjust, and/or store preferred configuration settings, the example configuration module 202 of FIG. 2 includes a user interface 218 and a settings database 220. The example user interface 218 interacts with the workstation(s) 108 to communicate with one or more practitioners regarding the manner in which the one or more practitioners desire the analysis module 120 to function. The example settings database 220 maintains a list of the configuration setting(s) associated with the one or more practitioners and provides access to the setting(s) to other elements of the analysis module 120 such as, for example, the data extractor 206 and/or the textual report generator 208.

In the illustrated example, the settings database 220 includes a first configuration setting (referred to herein as a secondary data retrieval setting) for each practitioner that controls which type and an amount of secondary data the corresponding practitioner prefers to review during an analysis. The secondary data retrieval setting can be altered (e.g., via the user interface 218) per individual scheduled analyses if the practitioner so desires. Further, the settings database 220 is capable of storing more than one secondary data retrieval setting for a practitioner for different types of analyses. That is, the practitioner may establish (e.g., via the user interface 218) one secondary data retrieval setting for pulmonary analyses and another secondary data retrieval setting for cardiac analyses. As described in greater detail below, the example data extractor 206 of FIG. 2 references the secondary data retrieval setting(s) when obtaining secondary data to be reviewed during an analysis. The example settings database 220 includes a plurality of default configuration settings (e.g., different default configuration settings for different types analyses) to be used in the absence of practitioner instructions to the contrary.

In the illustrated example, the settings database 220 also includes a second configuration setting (referred to herein as a report generation setting) for each practitioner that controls the manner in which a report of the secondary data is generated. For example, acting in connection with a corresponding secondary data retrieval setting, the report generation setting may determine an order in which the secondary data, segments of which are obtained from a plurality of sources in some instances, is compiled and output as a report. Like the secondary data retrieval setting, the report generation settings can be altered per individual scheduled analyses if the practitioner so desires. Further, the settings database 220 is capable of storing more than one report generation setting for a practitioner for different types of analyses. As described in greater detail below, the example textual report generator 208 of FIG. 2 references the report generation setting(s) when generating a textual report of secondary data to be reviewed during an analysis.

The example patient detector 204 of FIG. 2 monitors the inpatient/outpatient system 117 and/or any other element of the medical information system 106 to detect, for example, an arrival of a patient scheduled for an analysis. That is, the example patient detector 204 detects when a patient checks in for an appointment associated with an analysis of primary data. In some examples, the patient detector 204 detects additional or alternative indications that an analysis is approaching such as, for example, an onset of a patient preparation procedure, an acquisition of images from one or more sources of healthcare information, and/or a transfer of healthcare images. In some examples, the patient detector 204 may also detect a scheduling of an analysis (e.g., when the patient schedules the analysis upon arriving at a healthcare enterprise). When the example patient detector 204 determines that a patient has arrived, the example patient detector 204 sends a signal (e.g., by setting a flag) to the example data extractor 206 instructing the data extractor 206 to initiate a retrieval of secondary data. Further, the example patient detector 204 determines which practitioner is scheduled for the analysis associated with the detected patient. The identity of the practitioner is conveyed to the data extractor 206 with the signal described above.

The example data extractor 206 of FIG. 2 receives the initiation signal and the identity of the practitioner from the patient detector 204 and begins a process of retrieving one or more pieces of secondary data and extracting data from the same. In some examples, the process of retrieving the secondary data and/or extracting information from the same may begin and/or take place at additional or alternative times and/or in response to additional or alternative triggers. The example data extractor 206 of FIG. 2 accesses the settings database 220 to obtain the secondary data retrieval configuration setting associated with the identified practitioner. As described above, this configuration setting indicates what type and/or the amount of secondary data the practitioner wants to review for this particular patient, analysis, type of analysis, etc. The example data extractor 206 then access one or more external and/or internal information sources capable of storing the secondary data to be retrieved.

For example, when the secondary data to be retrieved includes one or more aspects of a medical history (e.g., prior surgeries, prior x-rays, scans, ultrasounds, test results, findings, diagnosis, treatments, prescriptions, and/or any other potentially influencing aspects of a medical history) of the patient, the data extractor 206 accesses, for example, one or more of the components of the medical information system 106 of the first enterprise 102a (e.g., the hospital information system 112, the electronic medical records 113, the PACS 116, etc.), the XDS repository 110a of the first enterprise 102a, one or more medical information systems of the other healthcare enterprises 102b-d, one or more of the other XDS repositories 110b-d. The data extractor 206 may access additional or alternative sources of information for one or more of the desired aspects of the medical history. To find the desired secondary data, the example data extractor 206 of FIG. 2 implements a search function capable of searching one or more of the example information sources described above.

The secondary data desired by the practitioner often includes information from an order associated with the primary data to be analyzed. For example, when a physician orders an analysis of a radiology image from a radiologist, the physician generates an order having details of why the analysis is needed, what the physician would like know, suspicions of the physician, and/or any other information useful in facilitating an effective analysis. In the illustrated example, the order can be stored in any suitable component of the medical information system 106, the workstation(s) 108, and/or in the memory of the analysis module 120. The example data extractor 206 of FIG. 2 includes a default setting causing the data extractor 206 to retrieve the information of the order described above.

When the example data extractor 206 has identified and/or retrieved the desired secondary data from one or more of the information sources described above, the example data extractor 206 extracts the information therefrom. For example, when the desired secondary data includes a lab result from the lab information system 115, the example data extractor 206 reads and stores one or more findings (as designated by the practitioner in the secondary data retrieval configuration setting) from the lab report. In another example, when the desired secondary data includes a set of radiology images from the radiology imaging system 114, the example data extractor 206 reads and stores those of the radiology images related to the anatomy to be analyzed by the practitioner. The subject of the analysis and the corresponding anatomy can be conveyed to the data extractor 206 (e.g., by the patient detector 206), obtained by the data extractor 206, and/or input by the practitioner. Other types of information, such as a physician's notes section of an order form associated with the analysis, are directly extracted by the data extractor 206.

In the illustrated example of FIG. 2, the data extractor 206 conveys the extracted secondary data to the textual report generator 208. The example textual report generator 208 accesses the settings database 220 to obtain the report generation configuration setting associated with the practitioner corresponding to the extracted secondary data. As described above, the report generation configuration setting determines a format of a textual report to be created having the secondary data included therein. The example textual report generator 208 of FIG. 2 generates a textual report according to the report generation configuration setting that includes the secondary data retrieved by the data extractor 206.

The textual report generator 208 is configured to generate a report in an electronic format such that the text-to-audio converter 210 can interpret the contents of the textual report. The example text-to-audio converter 210 of FIG. 2 receives the textual report and converts the same into an audio file. Although the example analysis module 120 of FIG. 2 includes the text-to-audio converter 210, other examples may include additional or alternative converters that create additional or alternative types of file reflecting the contents of the textual report generated by the textual report generator 208. In the illustrated example, the text-to-audio converter 210 transfers the resulting audio file to the hospital information system 112 with additional patient information (e.g., metadata identifying the corresponding patient). In some examples, the text-to-audio locally stores the resulting audio file in a local memory, which may include a main memory and one or more caches.

The example analysis initiation detector 212 of FIG. 2 monitors one or more of the workstation(s) 108 for an activation of, for example, a program associated with the analysis module 120. For example, when a practitioner begins an analysis of a set of radiology images at one or more example workstation(s) 108 of FIG. 1, the practitioner may activate a program or application dedicated to interacting with the radiology information system 114. In the illustrated example, the analysis initiation detector 212 detects the activation of the dedicated application. In response, the example analysis initiation detector 212 begins monitoring the activated application for one or more onsets of one or more analyses. That is, the example analysis initiation detector 212 detects a selection of an analysis from, for example, a menu or list of analyses scheduled to be performed by the practitioner using the application. The selection(s) detected by the analysis initiation detector 212 causes the display of the primary data such as, for example, radiology images of a focused area of the patient's anatomy.

In the illustrated example, when the analysis initiation detector 212 detects a selection by the practitioner to begin an analysis (e.g., causing a presentation of one or more images or other type of information on a display device), the analysis initiation detector 212 retrieves the audio file corresponding to the initiated analysis from the hospital information system 112 (and/or the another location such as, for example, a local memory) using metadata detected by the analysis initiation detector 212 from the dedicated application, and conveys the same to the communication interface 200. The communication interface 200 is configured to communicate with an audio presentation device, such as a speaker, and to cause the audio file to be presented to the practitioner. Thus, when the practitioner selects an analysis and initiates a display of the primary data (e.g., on a monitor configured to display radiology images and/or any other type of clinical image) the audio file including the secondary data is presented to the practitioner. As described above, this enables the practitioner to review the primary data in light of the secondary data without breaking visual contact with the primary data. As a result, the practitioner maintains his or her concentration during such an intense visual activity, thereby increasing efficiency, effectives, and/or otherwise improving the analysis of the healthcare information.

In the illustrated example, the detection of the selection of a scheduled analysis by the analysis initiation detector 212 also triggers the example graphical/verbal user interface 214 of FIG. 2. The example graphical/verbal user interface 214 of FIG. 2 facilitates an interaction between the reviewing practitioner and the audio information being presented via the communication interface 200. As described above, the example textual report generator 208 and the example text-to-audio converter 210 of FIG. 2 work together (e.g., utilizing the report generation configuration setting associated with the corresponding practitioner in the settings database 220) to generate an audio file including one or more segments of secondary data. The graphical/verbal user interface 214 enables the practitioner to navigate the audio file. For example, the example graphical/verbal user interface 214 of FIG. 2 provides the practitioner the option to jump from one audio segment (e.g., a prior surgeries section) to another audio segment (e.g., a section dedicated to the reasons the analysis order was placed with the practitioner). The example graphical/verbal user interface 214 of FIG. 2 provides a visual indication of the beginning and end of each of these segments, along with a label indicating what type of information is included in each segment. Further, the example graphical/verbal user interface 214 enables the practitioner to skip segments with the press of button (e.g., a mouse button and/or a dedicated key on a keyboard and/or other input/output device). In some examples, the graphical/verbal user interface 214 is presented as an overlay on the images being reviewed. Further, the example graphical/verbal user interface 214 enables the practitioner to provide verbal commands to skip to one or more segments of the audio file (e.g., by stating a name of an audio segment such as “Prior Surgeries” or “Order Data”). In such instances, the practitioner need only speak a category of secondary data while viewing the primary data and the requested audio information is played to the practitioner, thereby maintaining the visual focus of the practitioner while reviewing secondary data.

The example graphical/verbal user interface 214 of FIG. 2 also enables the practitioner to retrieve additional or alternative segments and/or amounts of secondary data from, for example, the hospital information system 112. That is, the example graphical/verbal user interface 214 can receive a request for a certain type and/or amount of secondary data from the practitioner. In response, the example graphical/verbal user interface 214 facilitates the retrieval of the additional or alternative secondary information by, for example, instructing the example data extractor 206 of FIG. 2 to retrieve the secondary information according to instructions provided to the graphical/verbal user interface 214 by the practitioner. The other components of the example analysis module 120 can then convert the extracted secondary data into an audio file, which supplement the previously created audio file. Therefore, the example analysis module 120 of FIG. 2 enables a dynamic gathering of secondary data that can be audibly presented to the practitioner while the practitioner is visually reviewing, for example, healthcare images.

The example findings generation 216 of FIG. 2 enables the practitioner to create a report (e.g., as a form, a textual write up, a voice recording, etc.) summarizing and/or detailing the findings of the analysis of the primary data in light of the secondary data. In some examples, the audio information presented to the practitioner as secondary data may be added to the generated report using the findings generator. That is, one or more aspects of the secondary data (e.g., a detail of a medical history or an aspect of the order of the analysis) may be incorporated into the findings report (e.g., using a cut/paste operation). In the illustrated example, the findings generator 216 conveys the findings report to one or more components of the example medical information system (e.g., the hospital information system 112 or the EMR 113), where the findings report is accessible to other practitioner(s).

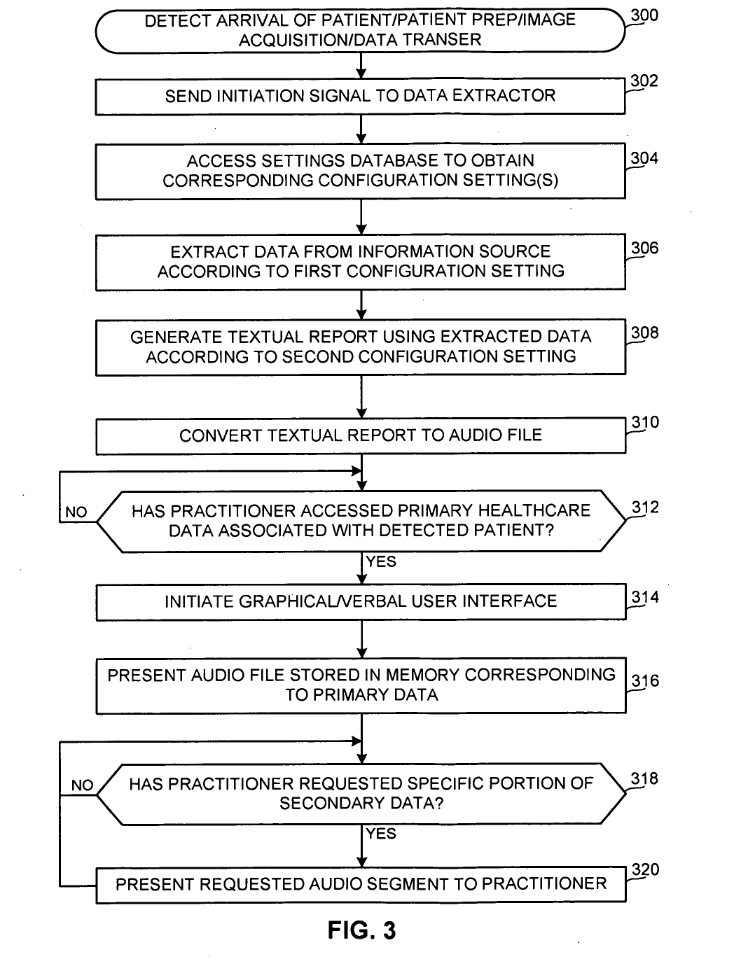

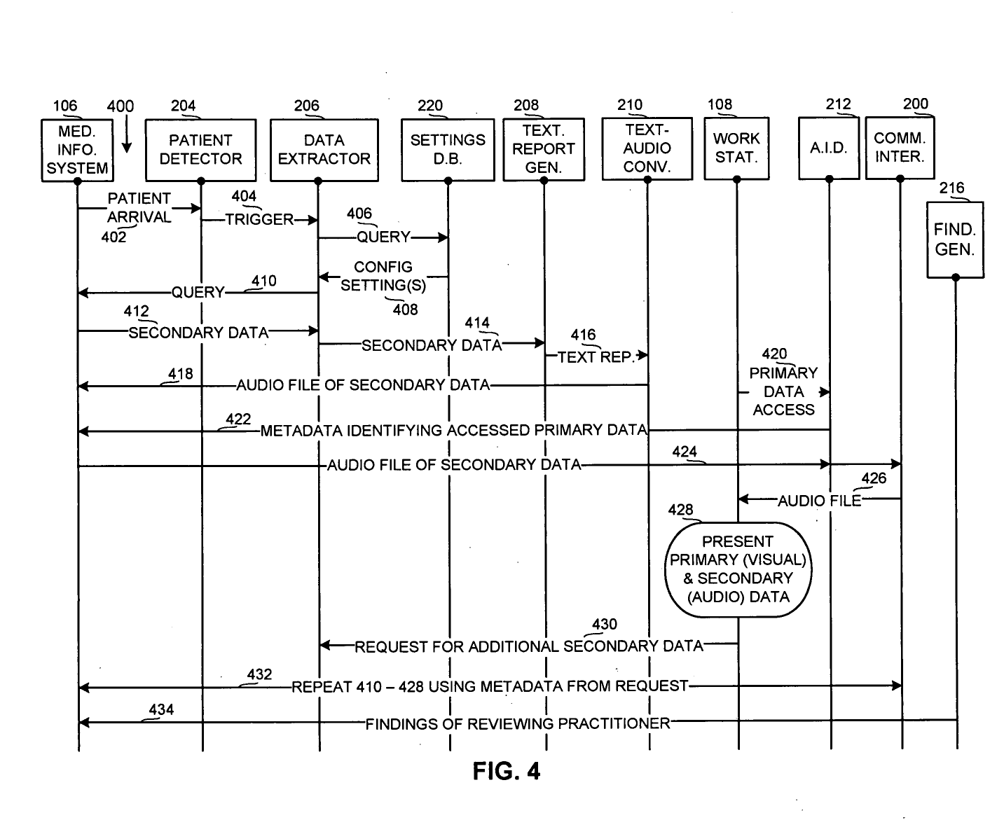

Turning to FIG. 3, the flow diagram depicted in FIG. 3 is representative of machine readable instructions that can be executed to implement the example analysis module 120 of FIGS. 1 and/or 2 to enhance healthcare information analyses. The example processes of FIG. 3 may be performed using a processor, a controller and/or any other suitable processing device. For example, the example processes of FIG. 3 may be implemented in coded instructions stored on a tangible medium such as a flash memory, a read-only memory (ROM) and/or random-access memory (RAM) associated with a processor (e.g., the example processor 412 discussed below in connection with FIG. 4). Alternatively, some or all of the example processes of FIG. 3 may be implemented using any combination(s) of application specific integrated circuit(s) (ASIC(s)), programmable logic device(s) (PLD(s)), field programmable logic device(s) (FPLD(s)), discrete logic, hardware, firmware, etc. Also, some or all of the example processes of FIG. 3 may be implemented manually or as any combination(s) of any of the foregoing techniques, for example, any combination of firmware, software, discrete logic and/or hardware. Further, although the example processes of FIG. 3 are described with reference to the flow diagram of FIG. 3, other methods of implementing the processes of FIG. 3 may be employed. For example, the order of execution of the blocks may be changed, and/or some of the blocks described may be changed, eliminated, sub-divided, or combined. Additionally, any or all of the example processes of FIG. 3 may be performed sequentially and/or in parallel by, for example, separate processing threads, processors, devices, discrete logic, circuits, etc.

In the illustrated example of FIG. 3, an arrival of a patient is detected at the first healthcare enterprise 102a of FIG. 1 (block 300). In particular, the example patient detector 204 detect (FIG. 2) determines that the newly arrived patient is scheduled to have one or more pieces of primary data analyzed by a specific practitioner. In the illustrated example, the patient detector 204, while monitoring the inpatient/outpatient system 117 (FIG. 1), determines that the detected patient corresponds to a scheduled analysis of radiology images of an ankle. In response, the example patient detector 204 sends a signal (e.g., by setting a flag) to the example data extractor 206 (FIG. 2) instructing the data extractor 206 to initiate a retrieval of secondary data (block 302). As described above in connection with FIG. 2, the signal sent by the patient detector 204 includes an identity of the practitioner designated for the scheduled analysis.

The example data extractor 206 accesses the settings database 220 (FIG. 2) of the configuration module (FIG. 2) to obtain one or more configuration settings associated with the identified practitioner (block 304). In the illustrated example, the data extractor 206 obtains a first configuration setting (referred to herein as a secondary data retrieval setting) and a second configuration setting (referred to herein as a report generation setting) associated with the identified practitioner. When obtaining the secondary data retrieval setting, the data extractor 206 determines that the scheduled analysis relates to a radiology image of an ankle. Additional or alternative categorizations of primary data are available. The data extractor 206 uses the categorization(s) associated with the scheduled analysis to obtain the correct configuration setting(s), as each practitioner may have different configuration setting(s) for one or more different types of analyses. The example data extractor 206 extracts the secondary data from one or more information sources according the obtained configuration setting (block 306). In the illustrated example, in which the subject of the scheduled analysis is an ankle, the secondary data to be retrieved includes prior surgeries or operations on the relevant ankle and/or any other relevant aspect of the corresponding leg (e.g., prior surgeries or operations on the knee), along with any medical records associated with those elements of the medical history. Further, in the illustrated example, the secondary data to be retrieved includes details related to the order placed for the scheduled analysis. In other words, the order accompanying the primary data includes information as to the reason(s) the analysis is needed and/or desired, and the data extractor 206 retrieves and extracts such information from, for example, the radiology information system 114 (FIG. 1).

The example textual report generator 208 (FIG. 2) receives the extracted secondary data and generates a textual report using the same according to the report generation configuration setting (block 308). The textual report generator 208 is configured to generate a report in an electronic format such that the example text-to-audio converter 210 (FIG. 2) can interpret the contents of the textual report. The example text-to-audio converter 210 receives the textual report and converts the same into an audio file of any suitable format (e.g., MP3, MP4, WAV, etc.) (block 310).

The audio file is conveyed to and stored in the hospital information system 112 (FIG. 1), where the audio file can be accessed by, for example, the communication interface 200 (FIG. 2). In the illustrated example, the example analysis initiation detector 212 (FIG. 2) monitors one or more systems and/or devices via which a practitioner can access the primary data such as, for example, one of the workstation(s) 108 (FIG. 1) (block 312). When the practitioner access the primary data associated with the identified patient described above (e.g., when the primary data is selected and displayed to the practitioner), the example analysis detector 212 triggers the graphical/verbal user interface 214 (FIG. 2) (block 314). To continue the above example, the analysis initiation detector 212 detects when the practitioner selects the radiology images of the problematic ankle for viewing. As described in above, the selection of the primary data for viewing by the practitioner causes a presentation of the audio file corresponding to the selected primary data (block 316).

In the illustrated example, the practitioner can hear the secondary data related to the primary data while maintaining visual focus and concentration on the primary data (e.g., the radiology images of the problematic ankle). Furthermore, the example graphical/verbal user interface 214 enables the practitioner to navigate the secondary data via graphical and/or verbal commands (e.g., via speech recognition capabilities). If the practitioner requests a certain portion or segment of the audio secondary data (block 318), the example graphical/verbal user interface 214 facilitates the presentation of the requested portion or segment (block 320). As a result, the practitioner maintains his or her concentration during such an intense visual activity, thereby increasing efficiency, effectives, and/or otherwise improving the analysis of the healthcare information.

FIG. 4 is a sequence diagram 400 representing machine readable instructions that may be executed to implement the example components of the example healthcare information system of FIGS. 1 and/or 2. When a patient arrives at a facility for a scheduled analysis, the example patient detector 204 (FIG. 2) receives a signal 402 (e.g., in response to a periodic and/or aperiodic query) indicating that a procedure corresponding to the scheduled analysis has begun. The patient in then put through a preparation process, the images to be analyzed may be loaded into a local memory in communication with the example analysis module 120, and/or data may be transferred to the analysis module 120 (e.g., via one or more of the XDS repositories 110a-d of FIG. 1). In the illustrated example, while one or more of the preparation processes are being performed, the example patient detector 204 sends a trigger 404 to the example data extractor 206.

As described above, the example data extractor 206 sends query 406 to the configuration settings database 220 to obtain one or more configuration settings (e.g., the report generation setting and/or the data retrieval setting). In the illustrated example, the settings database 220 conveys the configuration setting(s) 408 back to the data extractor 206, which sends a query 410 to the medical information system 106. In this example, the query 410 is forwarded to the hospital information system 112 and asks for certain amount(s) and/or type(s) of secondary data (e.g., in accordance with the configuration setting(s) associated with the practitioner corresponding to the detected scheduled analysis). The hospital information system 112 sends the requested secondary data 412 to the data extractor 206, which forwards the secondary data 414 to the textual report generator 208. As described above, the textual report generator 208 creates a textual report 416 and sends the same to the example text-to-audio converter 210. The example text-to-audio converter 210 converts the textual report 416 into an audio file according to one or more of the configuration settings associated with the reviewing practitioner. The example text-to-audio converter 210 conveys the resulting audio file 418 having the secondary data included therein to the medical information system 106 for storage in the hospital information system 112.

When the reviewing practitioner accesses the primary data associated with the scheduled analysis (e.g., causes a visual presentation of one or more healthcare images on a high-resolution configured for reviewing MRI scans), the example analysis initiation detector 212 (FIG. 2) receives a signal 420 indicative of the access. In response, the analysis initiation detector 212 conveys metadata 422 identifying the accessed primary data to the hospital information system 112 of the medical information system 106. In the illustrated example, the hospital information system 112 responds with the audio file 424 including the secondary data described above, which is conveyed to the analysis initiation detector 212 and the communication interface 200. As described above, the communication interface 200 cooperates with the workstation(s) 108 and/or a component thereof to present the audio file 426 to the reviewing practitioner in conjunction with the access primary data (block 428). That is, the practitioner can hear the secondary data related to the primary data while maintaining visual focus and concentration on the primary data (e.g., the radiology images of the problematic ankle).

As described above, the example graphical/verbal user interface 214 enables the practitioner to navigate the secondary data via graphical and/or verbal commands (e.g., via speech recognition capabilities) by, for example, requesting a certain portion or segment of the audio secondary data. Furthermore, the example graphical/verbal user interface 214 facilitates a retrieval of additional or alternative secondary data upon a request (e.g., using voice recognition capabilities) by the reviewing practitioner during the corresponding analysis. In the illustrated example of FIG. 4, when the workstation(s) 108 receive such a request, a request 430 for the additional or alternative secondary data is conveyed to the data extractor 206. The request includes identifying information indicative of the requested secondary data (e.g., an additional or alternative portion of a medical history associated with the patient that was not previously extracted by the data extractor 206). The example sequence diagram 400 of FIG. 4 shows the request 430 for the additional or alternative secondary data causing a repetition 432 of the processes described above in the example sequence diagram 400. In particular, the example data extractor 206 sends a query 410 to the medical information system 106 for the requested secondary data. The example analysis module 120 and the components thereof (e.g., the communication interface 200, the configuration module 202, the patient detector 204, the data extractor 206, the textual report generator 208, the text-to-audio converter, the analysis initiation detector 212, the graphical/verbal user interface 214) perform the subsequent processes described above, ultimately leading to a presentation of the requested additional or alternative secondary data in audio form in conjunction with a presentation of the primary data in visual form (e.g., block 428 in the example sequence diagram 400 of FIG. 4).

As the reviewing practitioner analyzes the primary data in conjunction with the secondary data, the example findings generation 216 (FIG. 2) enables the practitioner to create a report (e.g., as a form, a textual write up, a voice recording, etc.) summarizing and/or detailing the results of the analysis (e.g., the findings of the practitioner). In some examples, the audio information presented to the practitioner as secondary data may be added (e.g., automatically incorporated into) to the generated report using the findings generator. In the illustrated example of FIG. 4, the findings generator 216 conveys a findings report 434 to the example medical information system (e.g., the hospital information system 112 or the EMR 113), where the findings report 434 is accessible to other practitioner(s).

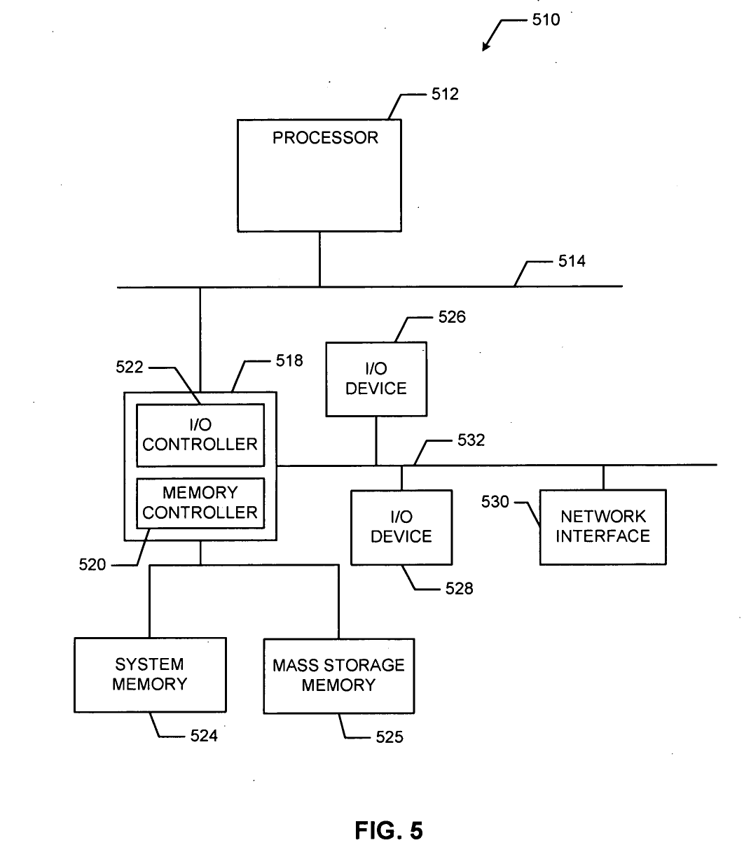

FIG. 5 is a block diagram of an example processor system 510 that may be used to implement the apparatus and methods described herein. As shown in FIG. 5, the processor system 510 includes a processor 512 that is coupled to an interconnection bus 514. The processor 512 may be any suitable processor, processing unit or microprocessor. Although not shown in FIG. 5, the system 510 may be a multi-processor system and, thus, may include one or more additional processors that are identical or similar to the processor 512 and that are communicatively coupled to the interconnection bus 514.

The processor 512 of FIG. 5 is coupled to a chipset 518, which includes a memory controller 520 and an input/output (I/O) controller 522. As is well known, a chipset typically provides I/O and memory management functions as well as a plurality of general purpose and/or special purpose registers, timers, etc. that are accessible or used by one or more processors coupled to the chipset 518. The memory controller 520 performs functions that enable the processor 512 (or processors if there are multiple processors) to access a system memory 524 and a mass storage memory 525.

The system memory 524 may include any desired type of volatile and/or non-volatile memory such as, for example, static random access memory (SRAM), dynamic random access memory (DRAM), flash memory, read-only memory (ROM), etc. The mass storage memory 525 may include any desired type of mass storage device including hard disk drives, optical drives, tape storage devices, etc.

The I/O controller 522 performs functions that enable the processor 512 to communicate with peripheral input/output (I/O) devices 526 and 528 and a network interface 530 via an I/O bus 532. The I/O devices 526 and 528 may be any desired type of I/O device such as, for example, a keyboard, a video display or monitor, a mouse, etc. The network interface 530 may be, for example, an Ethernet device, an asynchronous transfer mode (ATM) device, an 802.11 device, a DSL modem, a cable modem, a cellular modem, etc. that enables the processor system 510 to communicate with another processor system.

While the memory controller 520 and the I/O controller 522 are depicted in FIG. 5 as separate blocks within the chipset 518, the functions performed by these blocks may be integrated within a single semiconductor circuit or may be implemented using two or more separate integrated circuits.

Certain embodiments contemplate methods, systems and computer program products on any machine-readable media to implement functionality described above. Certain embodiments may be implemented using an existing computer processor, or by a special purpose computer processor incorporated for this or another purpose or by a hardwired and/or firmware system, for example.

Certain embodiments include computer-readable media for carrying or having computer-executable instructions or data structures stored thereon. Such computer-readable media may be any available media that may be accessed by a general purpose or special purpose computer or other machine with a processor. By way of example, such computer-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of computer-executable instructions or data structures and which can be accessed by a general purpose or special purpose computer or other machine with a processor. Combinations of the above are also included within the scope of computer-readable media. Computer-executable instructions comprise, for example, instructions and data which cause a general purpose computer, special purpose computer, or special purpose processing machines to perform a certain function or group of functions.

Generally, computer-executable instructions include routines, programs, objects, components, data structures, etc., that perform particular tasks or implement particular abstract data types. Computer-executable instructions, associated data structures, and program modules represent examples of program code for executing steps of certain methods and systems disclosed herein. The particular sequence of such executable instructions or associated data structures represent examples of corresponding acts for implementing the functions described in such steps.

Embodiments of the present invention may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

Although certain methods, apparatus, and articles of manufacture have been described herein, the scope of coverage of this patent is not limited thereto. To the contrary, this patent covers all methods, apparatus, and articles of manufacture fairly falling within the scope of the appended claims either literally or under the doctrine of equivalents.

What is claimed is:

1. A computer implemented method for use with a healthcare information system, comprising:
automatically detecting a scheduled analysis of healthcare information associated with a patient based on a detection of the patient;
retrieving textual data corresponding to a medical history of the patient from an information source according to a first configuration setting, wherein the first configuration setting controls which of a plurality of aspects of the medical history is to be retrieved;
generating a report using the textual data according to a second configuration setting, wherein the second configuration setting controls an organization of the generated report;
converting the report to an audio file and storing the audio file in memory; and
in response to detecting an initiation of the scheduled analysis, outputting at least a first segment of the audio file on a presentation device associated with the scheduled analysis in conjunction with a presentation of one or more images associated with the scheduled analysis.

2. A computer implemented method as defined in claim 1, further comprising retrieving textual data corresponding to an order associated with the scheduled analysis and including the textual data corresponding to the order associated with the scheduled analysis in the report.

3. A computer implemented method as defined in claim 1, further comprising receiving a command from a practitioner and, in response, outputting a second segment of the audio file on the presentation device.

4. A computer implemented method as defined in claim 3, wherein the first segment of the audio file corresponds to a first one of the plurality of aspects of the medical history and the second segment of the audio file corresponds to a second one of the plurality of aspects of the medical history.

5. A computer implemented method as defined in claim 3, wherein the first segment of the audio file includes information related to an order associated with the scheduled analysis and the second segment of the audio file includes information related to prior medical procedures experienced by the patient.

6. A computer implemented method as defined in claim 1, wherein the scheduled analysis comprises analyzing medical images corresponding to the patient.

7. A computer implemented method as defined in claim 1, further comprising enabling a practitioner to change the first configuration setting such that the textual data retrieved from the information source is of a different categorical value.

8. A tangible machine readable medium having instructions stored thereon that, when executed, cause a machine to:
automatically detect a scheduled analysis of healthcare information associated with a patient based on a detection of the patient;
retrieve textual data corresponding to a medical history of the patient from an information source according to a first configuration setting, wherein the first configuration setting controls which of a plurality of aspects of the medical history is to be retrieved;
generate a report using the textual data according to a second configuration setting, wherein the second configuration setting controls an organization of the generated report;
convert the report to an audio file and storing the audio file in memory; and
in response to detecting an initiation of the scheduled analysis, output at least a first segment of the audio file on a presentation device associated with the scheduled analysis in conjunction with a presentation of one or more images associated with the scheduled analysis.

9. A tangible machine readable medium as defined in claim 8 having instructions stored thereon that, when executed, cause a machine to retrieve textual data corresponding to an order associated with the scheduled analysis and to include the textual data corresponding to the order associated with the scheduled analysis in the report.

10. A tangible machine readable medium as defined in claim 8 having instructions stored thereon that, when executed, cause a machine to receive a command from a practitioner and, in response, output a second segment of the audio file on the presentation device.

11. A tangible machine readable medium as defined in claim 10, wherein the first segment of the audio file corresponds to a first one of the plurality of aspects of the medical history and the second segment of the audio file corresponds to a second one of the plurality of aspects of the medical history.

12. A tangible machine readable medium as defined in claim 10, wherein the first segment of the audio file includes information related to an order associated with the scheduled analysis and the second segment of the audio file includes information related to prior medical procedures experienced by the patient.

13. A tangible machine readable medium as defined in claim 8, wherein the scheduled analysis comprises analyzing medical images corresponding to the patient.

14. A tangible machine readable medium as defined in claim 8 having instructions stored thereon that, when executed, cause a machine to enable a practitioner to change the first configuration setting such that the textual data retrieved from the information source is of a different categorical value.

15. An apparatus for use with a healthcare information system, comprising:
a detector to automatically detect a scheduled analysis of healthcare information associated with a patient based on a detection of a patient;
a data extractor to retrieve textual data corresponding to a medical history of the patient from an information source according to a first configuration setting, wherein the first configuration setting controls which of a plurality of aspects of the medical history is to be retrieved;
a report generator to generate a report using the textual data according to a second configuration setting, wherein the second configuration setting controls an organization of the generated report;
a converter to convert the report to an audio file and storing the audio file in memory; and
a communication interface to, in response to detecting an initiation of the scheduled analysis, output at least a first segment of the audio file on a presentation device associated with the scheduled analysis in conjunction with a presentation of one or more images associated with the scheduled analysis.

16. An apparatus as defined in claim 15, wherein the data extractor is to retrieve textual data corresponding to an order associated with the scheduled analysis and to include the textual data corresponding to the order associated with the scheduled analysis in the report.

17. An apparatus as defined in claim 15, wherein the communication interface is to receive a command from a practitioner and, in response, output a second segment of the audio file on the presentation device.

18. An apparatus as defined in claim 17, wherein the first segment of the audio file corresponds to a first one of the plurality of aspects of the medical history and the second segment of the audio file corresponds to a second one of the plurality of aspects of the medical history.

19. An apparatus as defined in claim 17, wherein the first segment of the audio file includes information related to an order associated with the scheduled analysis and the second segment of the audio file includes information related to prior medical procedures experienced by the patient.

20. An apparatus as defined in claim 16, further comprising a user interface to enable a practitioner to change the first configuration setting such that the textual data retrieved from the information source is of a different categorical value.
